(19) United States
(12) Patent Application Publication
(10) Pub. No.: US 2008/0281836 A1
(43) Pub. Date: Nov. 13, 2008

(54) SYSTEM AND METHOD FOR DISPLAYING AND NAVIGATING CONTENT ON A ELECTRONIC DEVICE

(75) Inventors: Elizabeth Dykstra-Erickson, San Francisco, CA (US); Jeffrey Paul Anderson, Clovis, CA (US); James Brooks Miller, Sunnyvale, CA (US); Alan Jacob Westbrook, San Jose, CA (US); Jon Shemitz, Santa Cruz, CA (US); Gabriel C. Dalbec, San Jose, CA (US)

Correspondence Address: BERRY & ASSOCIATES P.C., 9255 SUNSET BOULEVARD, SUITE 810, LOS ANGELES, CA, 90069, US

(73) Assignee: ACCESS SYSTEMS AMERICAS, INC., Sunnyvale, CA (US)

(21) Appl. No.: 12/025,051

(22) Filed: Feb. 4, 2008

Related U.S. Application Data
(60) Provisional application No. 60/888,522, filed on Feb. 6, 2007.

(51) Int. Cl. G06F 17/30

(52) U.S. Cl. 707/100; 707/E17.044

(57) ABSTRACT

A system and method for displaying and navigating content on a electronic device is disclosed. The system and method provides information describing files stored in one or more memory units in a electronic device by first cataloging file metadata residing at a plurality of memory units into a corresponding plurality of databases. The system and method then aggregates the file metadata cataloged in the plurality of databases into a single list, and delivers the aggregated file metadata list to an application running on the electronic device.

### CROSS-REFERENCE TO RELATED APPLICATION

This application claims the benefit under 35 U.S.C. §119(e) of U.S. Provisional Patent Application Ser. No. 60/888,522, entitled “System and Method for Reducing Navigation Complexity and Simplifying Locating and Using Content on a Mobile Device Using Folderlessness and Aggregation Techniques”, filed on Feb. 6, 2007, and incorporates by reference the disclosure contained in that application.

### BACKGROUND OF THE INVENTION

1) Field of the Invention

This invention relates generally to the field of displaying and navigating digital content on an electronic device. More specifically, this invention relates to a system and method for reducing complexity in the display of content on an electronic device, and facilitating convenient navigation of such content.

2) Background

Many electronic devices, such as personal digital assists, electronic phones and other devices having embedded software feature advanced capabilities typically associated with personal desktop computers. However, in comparison to desktop computers, some of these devices may have reduced viewing screens sizes and/or relatively inconvenient input mechanisms, e.g., minimized keypads, a small number of buttons, etc.

For desktop computer systems, Windows®, MacOS and other operating systems allow users to search for or navigate through files via a hierarchical display arrangement such as a file directory. In a typical hierarchical display, descriptive information identifying the files such as file name, data created, size, etc. (referred to collectively as ‘metadata’ and individually as ‘metadata parameters’) may be structured in a number of levels or folders. For example, a first level (main) file folder may be shown at a first level, a second level sub-folder of the main file folder may be shown indented to the lower right of the main file folder, and a third level including sub-folders of the second level may be further indented to the lower right of the respective second level sub-folders. While operating systems may provide mechanisms for disclosing and concealing information in a way that permits reasonably efficient browsing of large stores of items, hierarchical display arrangements tend to require a large display area in order to both present a large amount of file metadata and allow a user to easily view and navigate through such metadata. Another drawback is that users often forget where they have placed files and often have to spend significant amounts of time searching through a hierarchical arrangement to find the files they wish to locate.

In electronics devices with small display screen sizes, hierarchical displays are therefore unfeasible and/or impractical as the amount of display space available is insufficient to present a hierarchical display of file metadata in a manner that is clear and conducive to user navigation. For example, tasks such as browsing or searching for a specific item in a hierarchical display are problematic and inconvenient when using a electronic device, as the user typically cannot view all the results without considerable scrolling and navigating.

In addition to the constraints resulting from minimal display space, the display of file content on electronic devices may be adversely affected by other limitations. Electronic devices may store data internally (e.g., on SIM cards) with access to data via removable media such as SD cards. File metadata generated on a personal computer (PC), transferred to a removable card and then introduced to the electronic device often may not be processed in the same way, or at all, by the electronic device. This difficulty may cause disorganization in the formatting and display of file metadata from such sources on a electronic device.

Furthermore, users may require a significant amount of metadata to be presented in order to properly distinguish a file from other items. Due to limited screen-size, electronic devices typically only display few of the metadata parameters such as a file name and a creation or edit date. Additionally, the file names that are displayed are not always helpful in identifying the actual content contained in the files, as they may only be numerical identifiers that do not reveal to the user any indication of the file content. Thus, even the limited amount of metadata normally available on a electronic device may be of little help to the user. As indicated above, when file names are introduced from other systems or devices such as desktops, cameras or other electronic phones, automatic naming may introduce characters not readable on a electronic device due to the incompatibility between the character sets of the devices.

Due to these and other problems, users of electronic devices often cannot accurately determine whether the files that they wish to access are available on the electronic device.

A need therefore exists for a method and system of displaying and organizing file information on a electronic device that overcomes the above-noted problems and difficulties and provides a convenient, user-friendly and comprehensive display to enable navigation of the metadata related to all of the files on the electronic device.

### SUMMARY OF THE INVENTION

In a first aspect, the present invention provides a method of providing information describing files stored in one or more memory devices in a electronic device. The method includes cataloging file metadata residing at a plurality of file memory devices into a corresponding plurality of databases, aggregating the file metadata cataloged in the plurality of databases into a single list, and delivering the aggregated file metadata listing to an application running on the electronic device.

In a second aspect, the present invention provides a electronic device comprising a processing unit, a first memory unit coupled to the processing unit, a second memory unit coupled to the processing unit, and a display screen coupled to the processing unit. The processing unit is adapted to catalog file metadata residing at the first and second memory units into first and second databases, aggregate the file metadata cataloged in the first and second databases into a single list; and deliver the aggregated file metadata list to an application running on the electronic device viewable on the display screen.

Additional features and advantages of the invention will be set forth in the description which follows, and in part will be obvious from the description, or may be learned by practice of the invention.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a schematic block diagram of an exemplary electronic device according to an embodiment of the present invention.

FIG. 2 is a schematic block diagram showing files stored in a memory unit of the electronic device according to an embodiment of the present invention.

FIG. 3 is a schematic block diagram illustrating a file metadata cataloging process according to an embodiment of the present invention.

FIG. 4 is a schematic block diagram illustrating a metadata extraction process according to an embodiment of the present invention.

FIG. 5 is a schematic front view of a electronic device according to an embodiment of the present invention.

FIG. 6A shows an exemplary media selector user interface according to an embodiment of the present invention.

FIG. 6B shows a filter operation performed using the media selector according to an embodiment of the present invention.

FIG. 6C shows a sort operation performed using the media selector according to an embodiment of the present invention.

FIG. 7 is a schematic illustration of a database query for aggregating metadata content across storage locations according to an embodiment of the present invention.

### DETAILED DESCRIPTION

The present invention provides a system and method in which metadata describing files stored in all memory units embedded in or coupled to a electronic device are aggregated into a single continuous list which can be accessed by any application running on the electronic device. In some embodiments, the list includes iconic representations that may readily notify the user of certain pertinent information about one or more files in the aggregated list. The iconic representations may indicate, for example, the memory unit at which the associated file is stored (e.g., internal memory, removable card), or whether the user has rights to access the content of the file (i.e., whether it is protected by forward lock or another digital right management scheme).

According to illustrative embodiments of the present invention, the aggregated list may present standard file metadata that includes parameters such as file name, file size, and date created, and may be presented in a user interface that allows the users to perform operations on the list such as filtering and sorting. These and other operations enable the user to manipulate the list in various ways. For example, the list can be filtered by content type to display only files of a particular content type, to display only specified metadata parameters, and/or to collapse the display so as to show metadata that helps the user to quickly narrow a search. For content types that have specific metadata, such as audio, an aggregated list filtered according to such content types presents such specific metadata.

Content in a “folderless” (data not stored in folder structures) environment can be shared by any application that can handle that content type. In an exemplary embodiment of the present invention, metadata is stored on the same media as the files it references. This saves space, and improves the chances that metadata will be up to date. However, if a removable card is write-protected, the metadata may be redirected to internal memory. File references that are stored external to the system may be represented by URLs, which describe the storage media with a unique identifier.

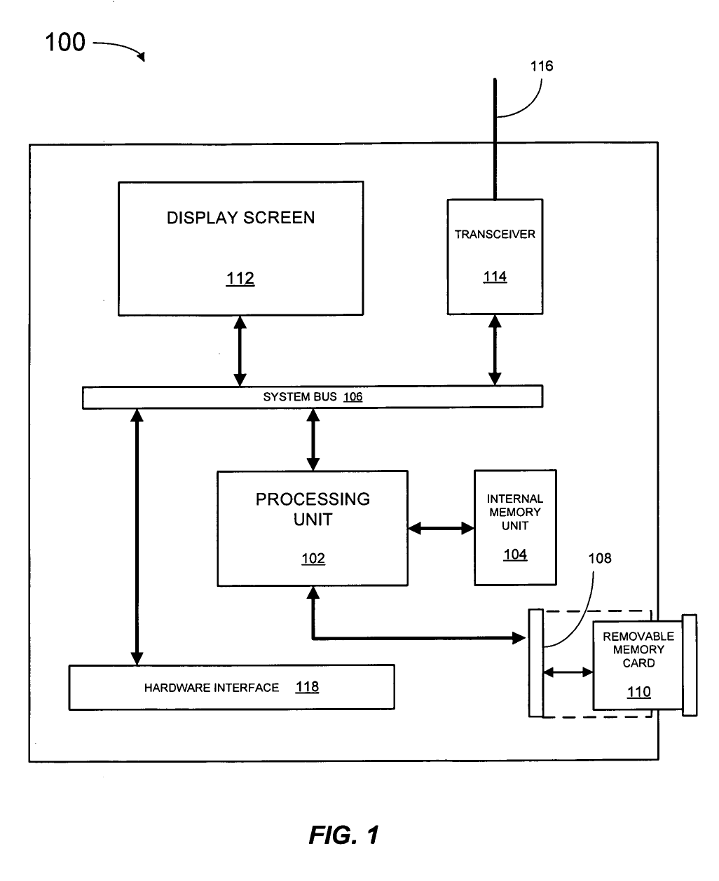

FIG. 1 is a schematic block diagram of an exemplary electronic device 100 embodied in accordance herewith which may comprise a portable computer, a personal digital assistant (PDA), an enhanced cell phone, or any other device having an embedded processor and/or wireless communication capability. The electronic device 100 includes a processing unit 102 adapted to run an operating system platform and application programs. The processing unit 102 is also adapted to control the other components of the electronic device 100 about to be discussed. An internal memory unit (hereinafter termed ‘memory unit A’) 104, which may comprise an internal memory card (e.g., SIM card), for example, may include read-only-memory (ROM) to store system-critical files and random access memory (RAM) to store other files as needed (see FIG. 1). The electronic device 100 may also include a removable memory card interface 108 adapted to read an insertable/removable memory card 110 such as a flash memory SD card (hereinafter referred to as ‘memory unit B’). Both memory units A 104 and B 110 may store files accessible by users of the electronic device 100 including, but not limited to, application programs, documents (e.g., text, pdf), and media files having audio, graphic and/or video content.

A display screen 112 is coupled to the processing unit 102 via a system bus 106 and thereby receives input from the processing unit 102 which determines the content displayed on the screen 112. The electronic device 100 also includes a transceiver unit 114 coupled to an antenna 116 and to the processing unit 102. The transceiver 114 provides for transmission and reception of wireless signals over a designated range of frequencies, allowing the electronic device 100 to connect to external devices and networks such as a wireless telephone network or the Internet. Data received from external sources via the transceiver 114, such as media content obtained from an online depot, may be delivered via the system bus 106 to the processing unit 102 and thereafter stored in memory units A 104 and B 110. A hardware interface 118 is coupled to buttons and/or switches on the body of the electronic device 100 (not shown) and provides signals to the processing unit 102 regarding the state and operation of such switches and buttons via the system bus 106.

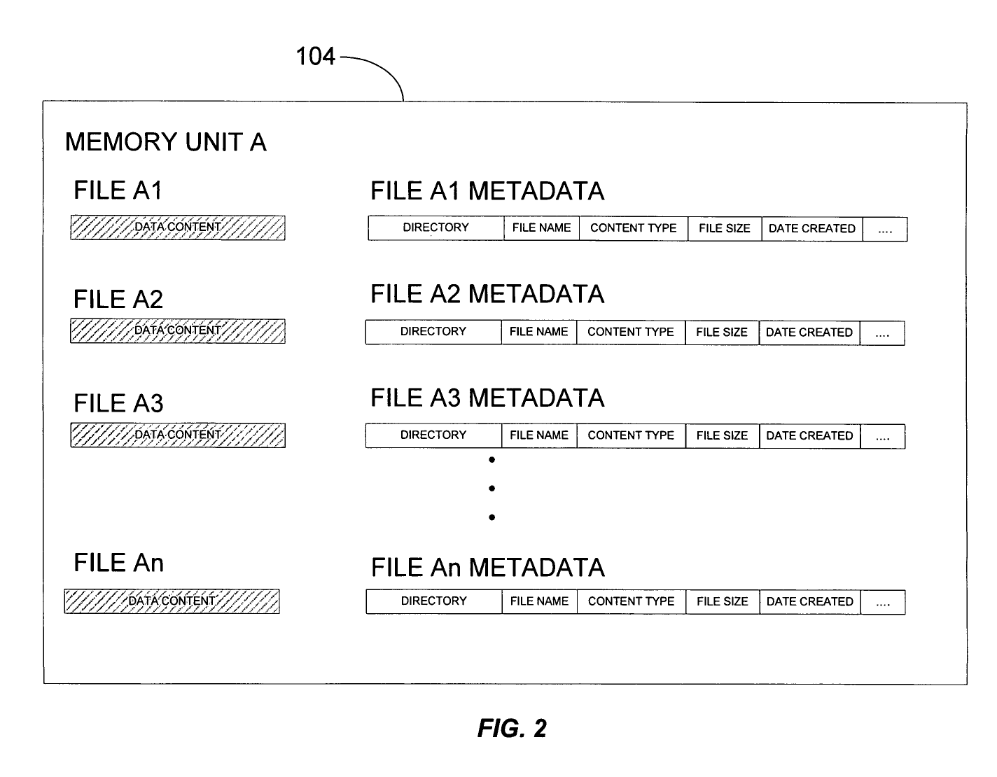

Turning to FIG. 2, a schematic representation of files stored in memory unit A 104 is shown. As depicted, memory unit A 104 includes files A1, A2, A3 . . . An, each file comprising a quantity of data content. In a preferred embodiment of the present invention, memory unit A also includes metadata associated with each file A1, A2, A3 . . . An, referred to as file metadata A1, file metadata A2, file metadata A3 . . . file metadata An. In some embodiments, file metadata A1, A2, A3 . . . An may be located proximate to or contiguous with the content of files A1, A2, A3 . . . An, in a header or footer, for example. This is not necessary however, and at a portion or all of file metadata A1, A2, A3 . . . An may be located elsewhere in memory unit A 104. In alternative embodiments, all or a portion of file metadata A1, A2, A3 . . . An may be located outside of memory A. For example, file metadata A1, A2, A3 . . . An may be located in a resource accessible online through a universal resource locator (URL). While the above text referred to memory unit A 104, the principles discussed apply equally to memory unit B 110, which may include files B1, B2, B3 . . . Bn and file metadata B1, B2, B3 . . . Bn.

In the exemplary embodiment shown (FIG. 2), the file metadata A1, A2, A3 . . . An includes parameters regarding: 1) the directory within memory unit A 104 in which the content of the corresponding file A1, A2, A3 . . . An is located; 2) the name of the file; 3) the content type, which indicates the filename extension, for example .doc, .pdf, .jpg, .wav, .avi; 4) file size; and the 5) the date the file was created. All of file metadata A1, A2, A3 . . . An, includes these parameters regardless of the content type and therefore these parameters are considered as generic. In addition to generic parameters, file metadata A1, A2, A3 . . . An may include further parameters that are specific to the content type of the corresponding files A1, A2, A3 . . . An. As an example, the content of file A1 may comprise music, such as a song. The file metadata A1 may include such parameters as the name of the song and the artist. In another example, the content of file A2 may comprise a photograph and the parameters of file metadata A2 may include a black/white vs. color identifier, resolution, etc. The use of specific metadata parameters is described in greater detail below.

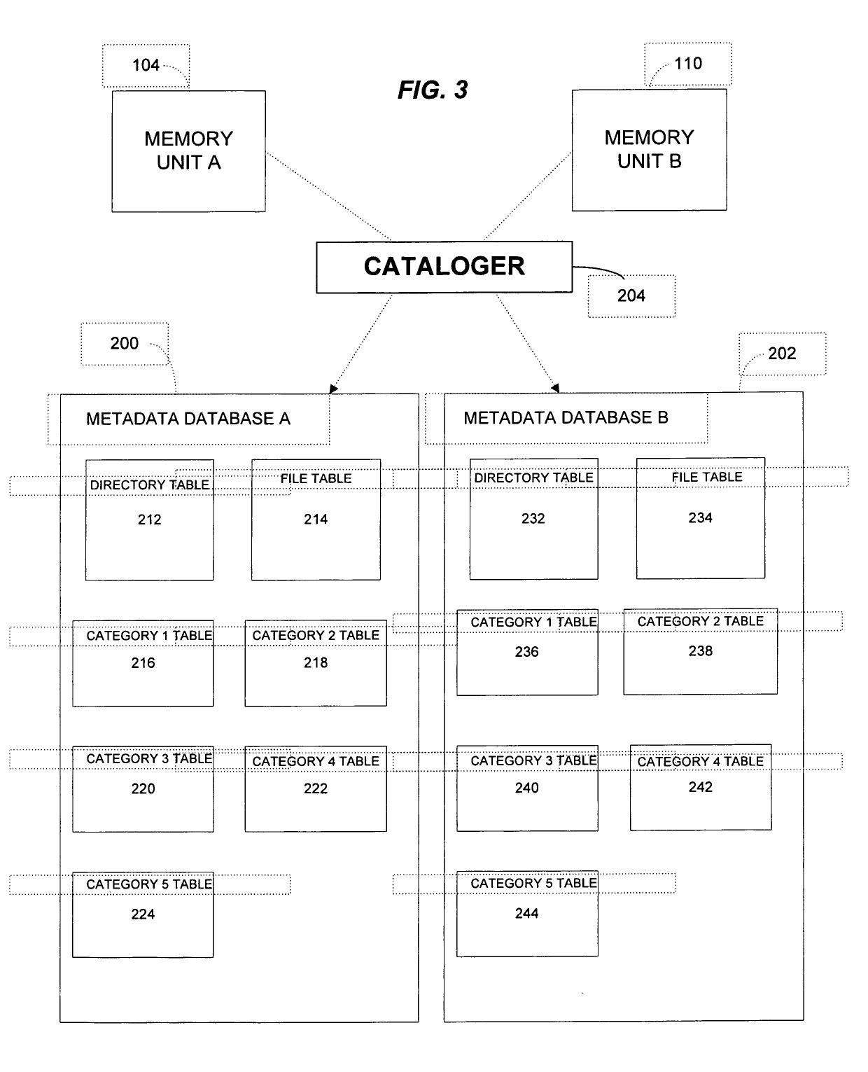

According to the present invention, the file metadata within the memory units of the electronic device 100, memory unit A 104 and memory unit B 110, is cataloged in corresponding databases 200 (metadata database A), 202 (metadata database B)(FIG. 3). In some embodiments, at the time the electronic device is turned on and its operating system is booted, a cataloger program 204 (‘cataloger’) is executed. As indicated in FIG. 3, which is a schematic block diagram illustrating an exemplary cataloging process, the cataloger scans memory unit A 104 and memory unit B 110 and reads and copies file metadata A1, A2, A3 . . . An in memory unit A 104 and file metadata B1, B2, B3 . . . Bn in memory unit B 110. More specifically, the cataloger 204 checks the directory indicated in the file metadata of each file, and if the directory is a registered directory that is not restricted (i.e., may include user-viewable content as opposed to, for example, a directory holding non-viewable system configuration files), the cataloger 204 reads and copies the file metadata.

After scanning and copying the file metadata of both memory unit A 104 and memory unit B 110, the cataloger 204 generates a database corresponding to memory unit A 104, metadata database A 200, and another database corresponding to memory unit B 110, metadata database B 202. In some embodiments of the invention, metadata databases A 200 and B 202 comprise relational databases. Metadata databases A 200 and B 202 may include respective directory tables 212, 232 having a folderless list of all file directories in corresponding memory units A 104 and B 110, and file tables 214, 234 which list metadata of all of files in rows, and generic parameters in field columns such as directory, file name, file size and content type.

Files having different extensions but that contain similar types of content (e.g., wav, .mpg, which are both audio file extensions) can be grouped together by category. The categories in which files may be identified are preset, but may be modified. In some embodiments of the present invention, the categories may represent the different media which a user of the electronic may call up when using the electronic device 100 including: applications (category 1), audio (category 2), documents (category 3), graphics (category 4), and video (category 5). Using the information in file tables 214, 234, the cataloger 204 generates a separate table for each category. In one embodiment, the cataloger creates category 1 table 216, category 2 table 218, category 3 table 220, category 4 table 222 and category 5 table 224 in metadata database A 200, and category 1 table 236, category 2 table 238, category 3 table 240, category 4 table 242 and category 5 table 244 in metadata database B 202. The category tables 216-224 are populated with the metadata from file table 214 of those files that are identified with the particular category. For example, category 2 table 218 (audio) is populated with metadata of the files in file table 214 identified under the audio category. The category tables 236-244 are similarly populated with data from file table 234. Each of the categories tables 216-224, 236-244 thereby comprise folderless lists of all of the files in corresponding memory units A 104 and B 110 that share the same type of content.

The category tables 216-224, 236-244 generated by the cataloger 204 include generic metadata but do not necessarily include metadata specific to each category as the cataloger, in some embodiments, does not parse the file metadata individually according to content type. For example, if the cataloger 204 scans a .jpg file indicating graphics content, the associated metadata may include parameters specific to graphical content such as picture resolution, but the cataloger 204 does not parse the metadata so as to extract the picture resolution metadata; the resulting category table (graphics) that includes the .jpg file therefore does not include the picture resolution information initially.

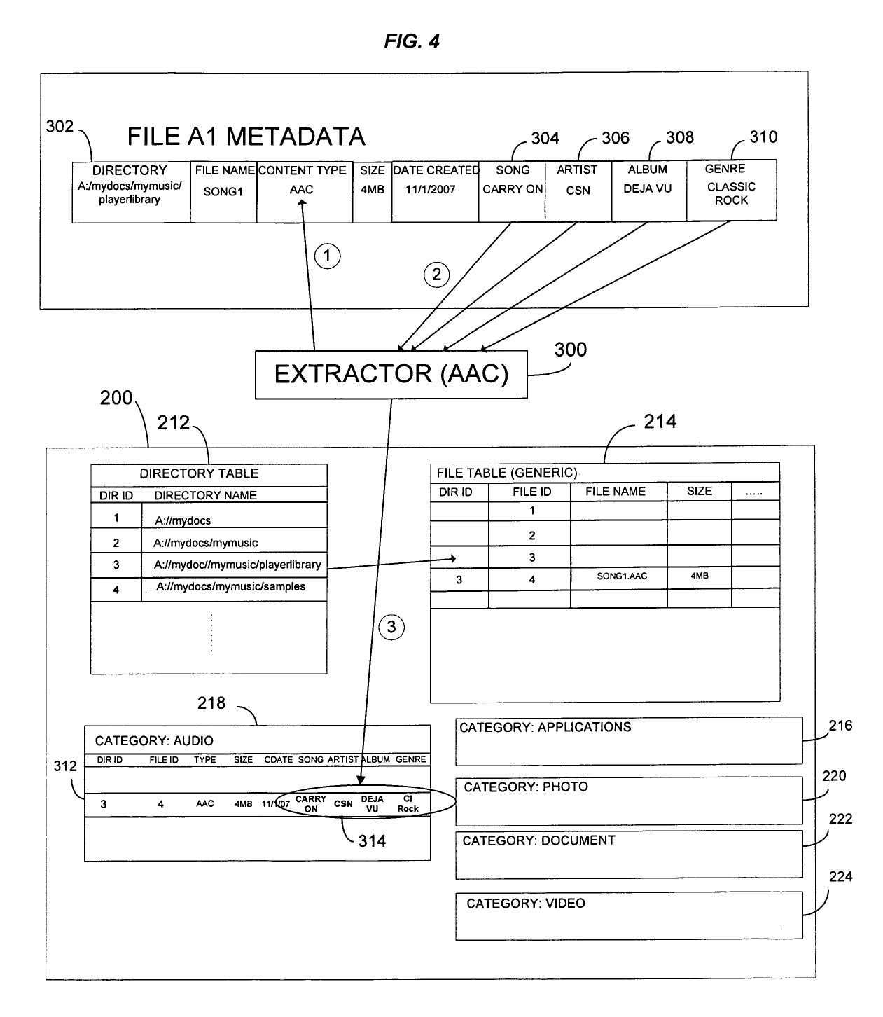

Referring now to FIG. 4, a schematic illustration of an exemplary extraction process is shown, in which an extractor 300 specific to a particular file extension (e.g., .jpg, .aac, .avi, .doc, .exe) extracts specific metadata from files, specific to the file extension, that can then be entered into the appropriate category table. The association between a file extension and the matching extractor may be determined dynamically, at runtime. The extraction process is repeated using different extractors to extract the specific metadata for any number of file extension types. Each extractor 300 is passed the files having the matching extension within category tables 216-224, 236-244. Thus a .jpg extractor may be passed the file information on 20 files in the graphics tables 222, 242 and an .avi extractor may be passed 4 files from the video tables 224, 244. After reading the specific metadata of those files identified from the category tables from memory units 104, 110, the extractor(s) then populate the category tables 216-224, 236-244 with the specific metadata.

In the example illustration shown in FIG. 4, an .aac (Advanced Audio Coding) extractor 300 is made aware that file listing 312 in the audio table 218 includes a .aac extension. In process step 2, the extractor 300 finds and extracts the metadata parameters: SONG 304, ARTIST 306, ALBUM 308, and GENRE 310 specific to the .aac file extension and then extracts the metadata (Song1, CSN, Déjà vu, Classic Rock) of file metadata listing 302. This is accomplished by specifying the parameters SONG, ARTIST, ALBUM and GENRE in the ‘manifest’ of the extractor 300, which determines how it extracts data. In process step 3, the extractor 300 passes the extracted metadata to the cataloger 200 which incorporates the extracted metadata into corresponding parameter fields 314 of entry 312. In this manner, all of the entries in the category tables 216-224, 236-244 may be populated using extractors 300. Additionally, by appropriately configuring their manifests, extractors 300 may be used to dictate the actual database structure and to extend the database dynamically to accommodate completely new metadata.

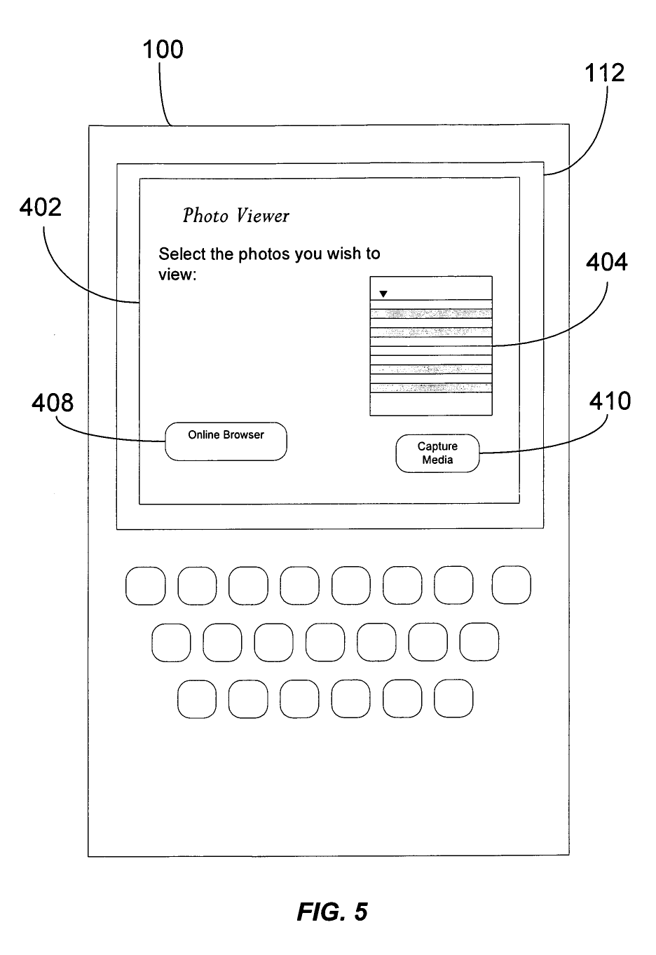

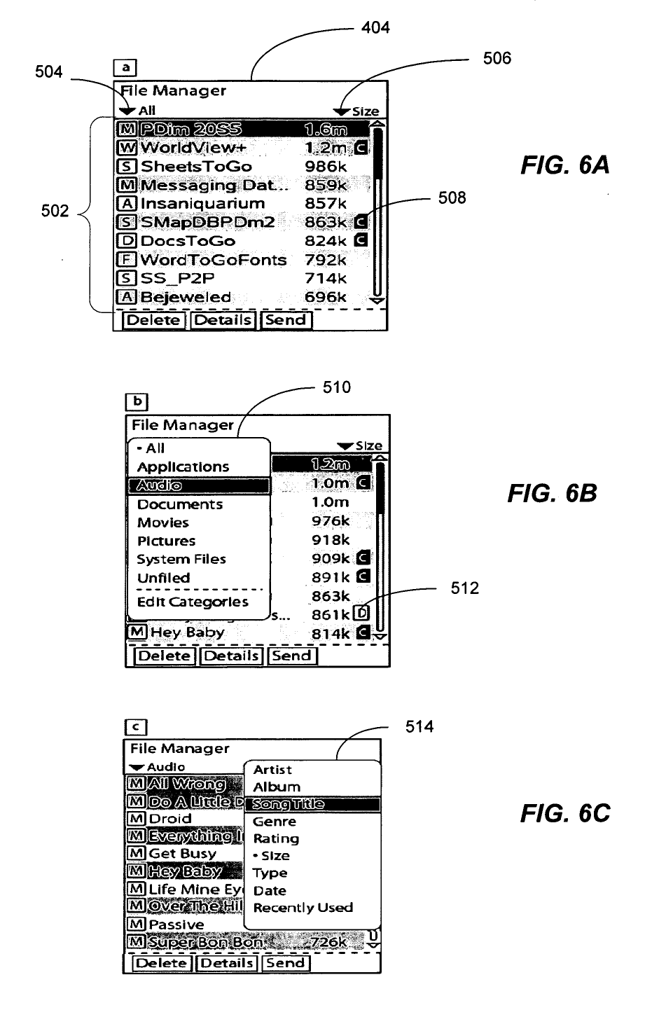

The cataloging and extraction processes discussed above may take place when the electronic device 100 is turned on or the operating system is booted. Afterwards, any application running on the electronic device 100 may access the metadata databases 200, 202 and obtain file metadata rapidly and efficiently. In particular, the present invention takes advantage of the pre-organized metadata by enabling applications to call up a media selector that interacts with metadata databases A 200 and B 202 via queries, allowing easy access to media file information across storage locations. In some embodiments, the media selector may be implemented using a user interface that presents media file metadata in a single, filterable listing. An example of a media selector user interface is illustrated and discussed with reference to FIGS. 5, 6A, 6B and 6C.

FIG. 5 is a schematic front view of the exemplary electronic device 100 according to an embodiment of the present invention. An example application (e.g., photo viewer) 402 is executed on the electronic device 100 and is presented on the display screen 112. Also presented in the display screen 112 is a media selector application 404 (‘media selector’) which may be used to present a listing of all file metadata entered into the metadata databases 200, 202 and to allow the user to select files for retrieval within application 402. The media selector 404 also enables filtering and sorting of the file metadata. The media selector 404 may be opened automatically when the application is run, or at other times. Once the media selector 404 is invoked and a file is selected (or to be more accurate, the metadata of the file is selected), the media selector 404 returns a file reference to the invoking application 402 that allows the application 402 to access the content of the selected file. An exemplary user interface for the media selector is shown in FIGS. 6A, 6B and 6C.

In some embodiments, additional plug-ins and features may be called up with the media selector 404. For example, a button 408 or similar item may be presented on the display screen 112, which when activated launches a plug-in that provides a browser interface and allows the user to navigate and select a reference to media on an online server. Another button 410 may be presented that allows the user to launch an application to capture and store some media, while returning a reference to the invoking application 402. This media may be different from media currently selected by the media selector.

FIG. 6A shows an exemplary implementation of a media selector 404 implemented as a dialog box according to an embodiment of the present invention. As shown, the media selector 404 (FIG. 5) presents an aggregated list 502 (FIG. 6A) of file metadata. While only two columns of data are shown (file name and file size), the dialog box can be expanded to show more data (or reduced in size to show less data). The media selector 404 includes a first dropdown pointer 504 that exposes filters and sub-filters that delimit the list of metadata displayed according to category, or other criteria, and a second dropdown pointer 506 that exposes sorting criteria. In some embodiments, the media selector 404 displays identifiers, such as icons, with the file metadata to provide additional useful information about the files to the user.

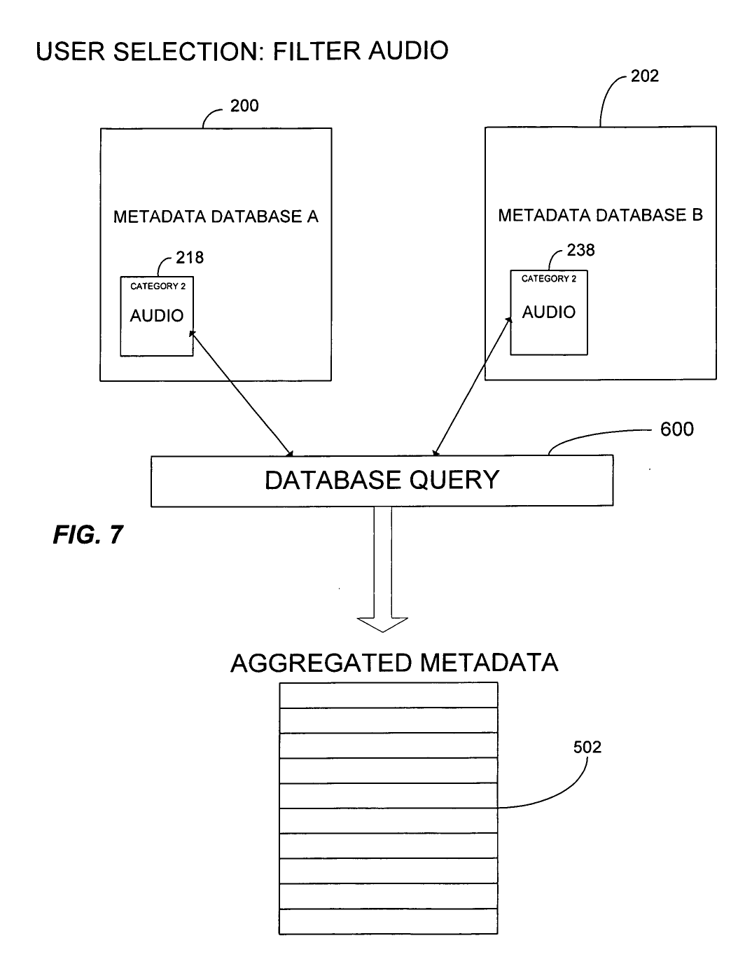

FIG. 6B shows the media selector with a filter dropdown menu 510 activated via the dropdown pointer 504, listing categories which the user may select for filtering the listed metadata 502. In the example shown, the audio category is selected as a filter criterion. Selection of the audio category launches a database query which is schematically illustrated in FIG. 7. The database query 600, which may be implemented using SQLite, for example, scans and retrieves the metadata from the audio category (category 2) tables 218, 238 in databases 200, 202. The metadata retrieved from tables 218, 238 may be returned by the query to the media selector user interface 404 in a single, aggregated list 502 including the metadata content of both tables 218, 238. According to this method, the metadata content is presented to the invoking application 402 in such a way that the application 402 is insulated from and does not need to have access to the storage location of the files listed in the media selector 404. Once the audio files are listed in the media selector 404, further filters (e.g., by artist, genre) may be applied to further narrow the listed results.

Returning to FIG. 6A, notwithstanding the usefulness of aggregating the metadata from a plurality of storage locations, it may be useful to indicate the source of certain files on the aggregated list 502. For example, if a media file that the user wishes to access is stored in removable memory unit B 110, it may be useful to notify the user of this so that memory unit B 110 is not removed from the electronic device 100 before the media is accessed. To provide such notification, in some embodiments, the media selector 404 provides an indication of the files that are stored in memory unit B 110 by displaying an icon shaped as a box and marked “C” (card) 508 adjacent to the file metadata entries of those files in the aggregating listing 502. FIG. 6B shows another useful identifier which may be used: a box marked “D” 512 which may be displayed in a similar manner to indicate that the file is subject to digital right management.

FIG. 6C shows the media selector with the sort dropdown menu 514 activated via the sort dropdown pointer 506, listing the sorting parameters based on the audio filter 510 shown in FIG. 6B. In the example shown, the song title is selected so that the list 502 may be presented in alphabetical order according to song title. The list may be presented in reverse order by re-activating the sort drop-down pointer 506, for example.

It is to be understood that the foregoing illustrative embodiments have been provided merely for the purpose of explanation and are in no way to be construed as limiting of the invention. For example, while the embodiments disclosed largely discuss metadata in local storage locations, the principles of the present invention also apply to external memory locations, such as online depots. For example, metadata stored externally may be cataloged in a local database, extracted and aggregated in the same manner as are the internal memory and removable memory card.

Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. In particular, while the invention has been described with reference to electronic devices such as personal digital assistants, electronic phones, smart phones, camera phones, pocket personal computers and the like, the invention applies equally to other devices having embedded software including, for example, televisions, media players, automotive navigation devices, GPS devices and portable gaming devices (e.g., Sony Play Station®).

Furthermore, although some of the advantages of the present invention may apply particularly to devices having small display screens, the media selector user interface provided according to the present invention may also be used in other devices which employ a remote control or similar device for user input rather than a keypad, regardless of display size. Such devices are referred to herein as ‘information appliances’. In such devices, a remote control may be used to scroll through the entries in the media selector to search for and select an entry, removing the need to search for entries using alphanumeric input on a keypad. For example, a media selector may be displayed in a limited area on a television screen (of any size) along with regular program content.

In addition, the present invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

What is claimed is:

1. A method of providing information describing files to a user where the files are stored in one or more memory units of an electronic device, the method comprising the steps of:
cataloging file metadata residing at the one or more memory units of the electronic device into a corresponding plurality of databases;
aggregating the file metadata cataloged in the one or more databases into a single list; and
delivering the aggregated list to an application running on the electronic device.

2. The method of claim 1, further comprising the step of:
grouping file metadata in the one or more databases according to media type.

3. The method of claim 2, further comprising the step of:
displaying the aggregated file metadata list to the user on a user interface capability;
wherein file entries in the aggregated list may be selected by the user via the user interface capability for access by the application.

4. The method of claim 3, wherein the aggregated file metadata list is filterable according to at least media type.

5. The method of claim 3, further comprising the step of:
utilizing and displaying an icon adjacent to file metadata in the aggregated list indicating a characteristic of the corresponding file.

6. The method of claim 5, wherein the icon displayed identifies the memory unit in which the corresponding file is stored.

7. The method of claim 6, wherein the icon displayed identifies whether the corresponding file is locked or subject to digital rights management.

8. The method of claim 1, further comprising the step of:
extracting metadata for all file content types from the one or more memory units; and
populating the plurality of databases with the extracted metadata.

9. The method of claim 1, wherein the plurality of databases and the aggregated list are folderless.

10. An electronic device, comprising:
a processing unit;
a first memory unit coupled to the processing unit;
a second memory unit coupled to the processing unit; and
a display screen coupled to the processing unit;
wherein the processing unit is adapted to:
catalog file metadata residing at the first and second memory units into first and second databases;
aggregate the file metadata cataloged in the first and second databases into a single list; and
deliver the aggregated file metadata list to an application running on the electronic device viewable on the display screen.

11. The electronic device of claim 10, wherein the processing unit is further adapted to group file metadata in the first and second databases according to media type.

12. The electronic device of claim 11, wherein the processor is adapted to provide a user interface including the aggregated list and to allow a user to select file entries in the aggregated list for access by the application.

13. The electronic device of claim 10, wherein the first memory unit comprises an internal memory card and the second memory unit comprises a removable memory card.

14. The electronic device of claim 13, further comprising:
a transceiver coupled to the processing unit, the transceiver enabling data communication with an external network.

15. The electronic device of claim 14, wherein the external network is the Internet.

16. The electronic device of claim 15, wherein the processing unit is further adapted to search for and capture media content over the Internet.

17. A system of displaying content to a user on an electronic device where data files are stored in one or more memory units of the electronic device, the system comprising:
cataloging instructions for sorting file metadata residing at the one or more memory units of the electronic device into a corresponding plurality of databases;
aggregating logic for compiling the file metadata cataloged in the one or more databases into a single list;
delivery capability for delivering the aggregated list to an application running on the electronic device; and
user interface for displaying the aggregated list to the user, wherein file entries in the aggregated list may be selected by the user via the user interface for access by the application.

18. The system of claim 17, further comprising:
instruction routine to utilize the media type for grouping file metadata in the one or more databases.

19. The system of claim 18, wherein the aggregated list is filterable at least by the media type.

20. The system of claim 18, further comprising:
an icon display adjacent to file metadata in the aggregated list indicating a characteristic of the corresponding file.

21. The system of claim 20, wherein the icon display identifies at least one of the memory unit in which the corresponding file is stored and whether the corresponding file is locked or subject to digital rights management.

22. The system of claim 17, further comprising:
logic for extracting metadata for all file content types from the one or more memory units; and
mechanism for populating the plurality of databases with the extracted metadata.

23. The system of claim 17, wherein the plurality of databases and the aggregated list are not structured in folder configurations.
